(19) United States
(12) Patent Application Publication
(10) Pub. No.: US 2016/0014291 A1
(43) Pub. Date: Jan. 14, 2016

(54) ILLUMINATED REFERENCE GUIDE PATTERN

(71) Applicant: Hewlett-Packard Development Company, L.P., Houston, TX (US)

(72) Inventors: Wee Teck Woon, Vancouver, WA (US); Jing Su, Shanghai (CN); Eric Mun-Khai Leong, San Diego, CA (US); Say Meng Foo, Singapore (SG); Kian Hwee Harold Lim, Singapore (SG); Tushar Vijay Radke, Poway, CA (US)

(73) Assignee: Hewlett-Packard Development Company, L.P., Houston, TX (US)

(21) Appl. No.: 14/763,257

(22) PCT Filed: Feb. 26, 2013
(86) PCT No.: PCT/CN2013/071869

§ 371 Date: Jul. 24, 2015

(51) Int. Cl. H04N 1/00; H04N 1/10; H04N 1/028

(52) U.S. Cl. CPC H04N 1/00824; H04N 1/02815; H04N 1/1061; H04N 2201/0081; H04N 2201/0094

(57) ABSTRACT

An image capturing apparatus includes an illumination member to selectively provide a target reference to guide placement of the target within a field of view of an image capturing member. The illumination member may illuminate the at least one reference guide pattern in an illumination-on mode. The illumination member may also disable the target reference by not illuminating the at least one reference guide pattern in an illumination-off mode.

### BACKGROUND

Image capturing apparatuses such as multifunction printing systems may capture an image of a target. The image capturing apparatuses may include a receiving member to receive the target. The receiving member may include physical guides and/or printed patterns. The physical guides may extend outward from a surface of the receiving member. The printed patterns may be printed on the surface of the receiving member. The physical guides and the printed patterns may guide placement of the target into a field of view of the respective image capturing apparatus to form the image of the target.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram illustrating an image capturing apparatus according to an example.

FIGS. 2A-2C are perspective views illustrating an image capturing apparatus according to examples.

FIG. 3 is a schematic diagram of a portion of the image capturing apparatus of FIG. 2A according to an example.

FIG. 4 is a block diagram illustrating a multifunction printing system according to an example.

FIG. 5 is a flowchart illustrating a method of capturing an image of a target according to an example.

### DETAILED DESCRIPTION

Image capturing apparatuses such as multifunction printing systems may capture an image of a target. The image capturing apparatuses may include a receiving member to receive the target. The receiving member may include physical guides and/or printed patterns. The physical guides may extend outward from a surface of the receiving member. Alternatively, the printed patterns may be printed on a surface of the receiving member. The physical guides and the printed patterns may guide placement of the target into a field of view of the respective image capturing apparatus to form the image of the target. Physical guides extending outward from the surface of the receiving surface, however, may obstruct an ability to organize the target on the receiving member and the removal of the target there from. Also, the captured image of the target may include the printed pattern on the receiving member requiring removal by an image process resulting in an increased image processing time.

In examples, an image capturing apparatus may include an image capturing member, a platen, and an illumination member. The image capturing member may capture an image of a target. The platen may include a receiving member having at least one reference guide pattern. The receiving member may receive the target for the image capturing member to capture the image thereof. The illumination member may selectively provide a target reference to guide placement of the target within a field of view of the image capturing member. That is, the illumination member may selectively illuminate at least one reference guide pattern in an illumination-on mode and disable the target reference by not illuminating the at least one reference guide pattern in an illumination-off mode. For example, the reference guide pattern may be selectively turned off not to appear in the image of the target and not extend outward from a surface of the receiving member. Thus, the reference guide pattern may not obstruct the ability to organize and remove the target from the receiving member. Additionally, the image processing time may not increase as the image of the target may include the reference guide pattern which selectively blends into the industrial design of the receiving member at the time of image capture.

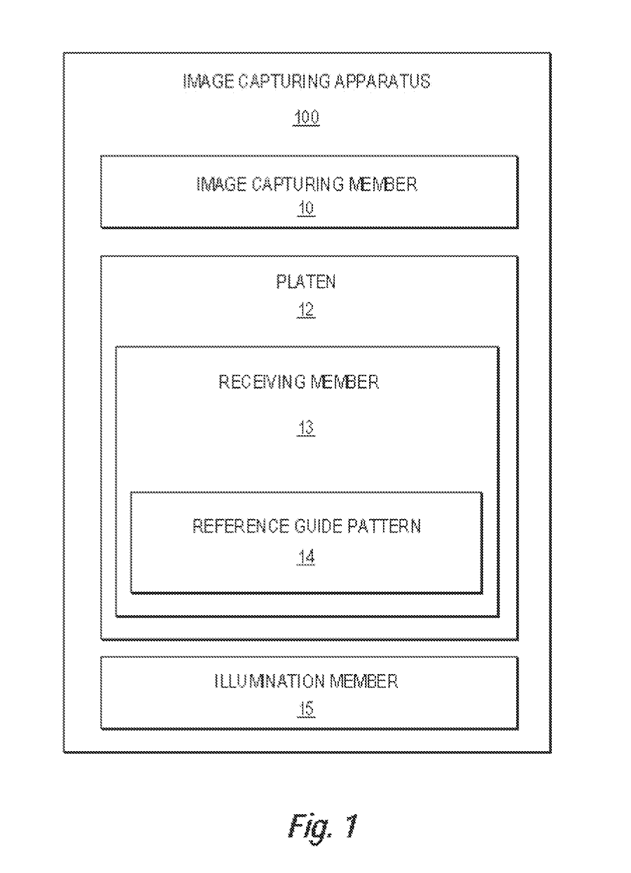

FIG. 1 is a block diagram illustrating an image capturing apparatus according to an example. Referring to FIG. 1, in some examples, an image capturing apparatus 100 includes an image capturing member 10, a platen 12, and an illumination member 15. The image capturing member 10 may capture an image of a target. The platen 12 may include a receiving member 13 having at least one reference guide pattern 14. The receiving member 13 may receive the target for the image capturing member 10 to capture the image thereof. In some examples, the receiving member 13 may be a substantially flat receiving surface.

Referring to FIG. 1, in some examples, the illumination member 15 may selectively provide a target reference to guide placement of the target within a field of view of the image capturing member 10 by illuminating at least one reference guide pattern 14 in an illumination-on mode. For example, the illumination member 15 may be turned on in the illumination-on mode. The illumination member 15 may selectively disable the target reference by not illuminating at least one reference guide pattern 14 in an illumination-off mode. For example, the illumination member 15 may be turned off in the illumination-off mode. Alternatively, in some examples, the target reference may be disabled by shielding the illumination member 15 from illuminating the target reference. In some examples, the illumination member 15 may be a light source such as light bulbs, light emitting diodes, and the like.

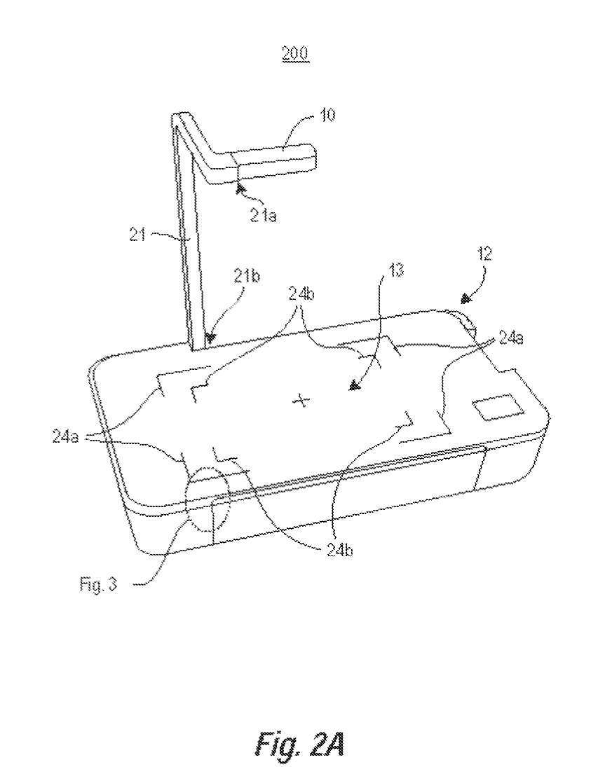

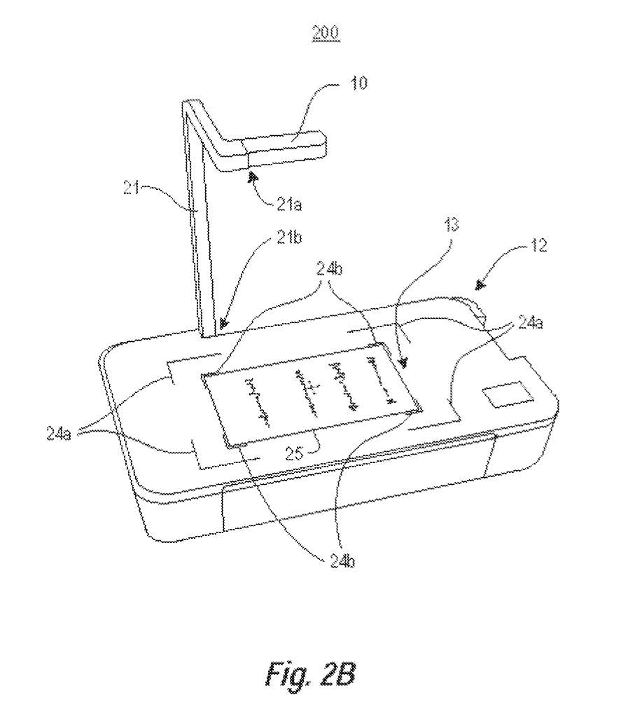

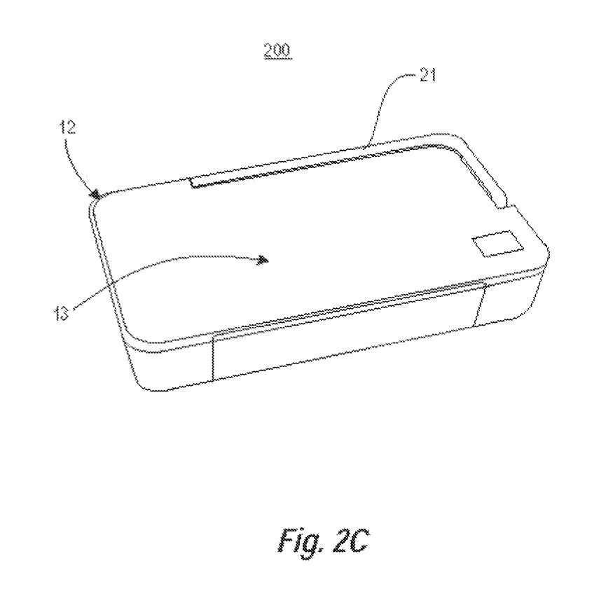

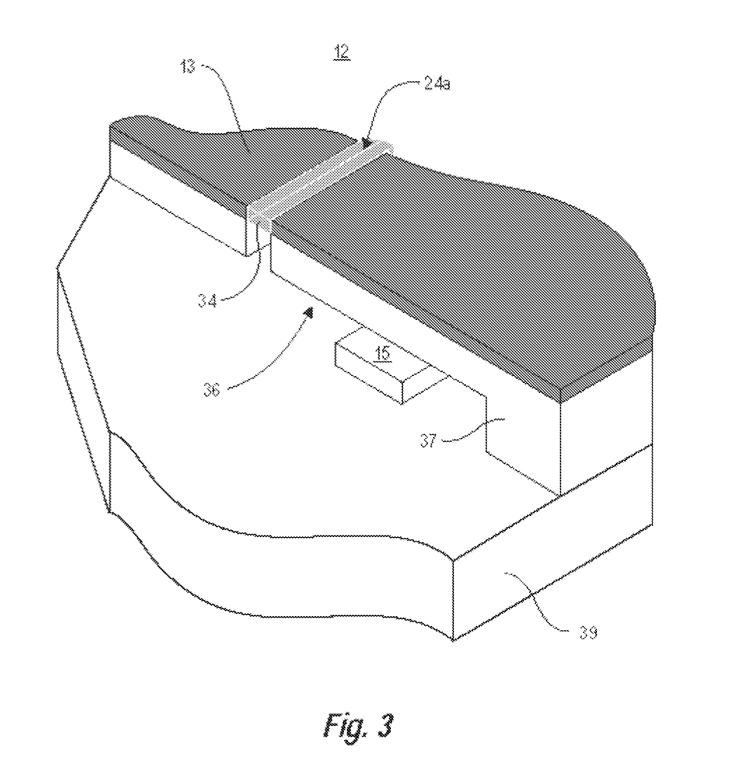

FIG. 2A is a perspective view illustrating an image capturing apparatus in an illumination-on mode according to an example. FIG. 2B is a perspective view illustrating the image capturing apparatus of FIG. 2A with a target there on in an illumination-on mode according to an example. FIG. 2C is a perspective view illustrating the image capturing apparatus of FIG. 2A in an illumination-off mode according to an example. FIG. 3 is a schematic diagram of a portion of the image capturing apparatus of FIG. 2A according to an example. Referring to FIGS. 2A-3, in some examples, an image capturing apparatus 200 may include the image capturing member 10, the platen 12, and the illumination member 15 as previously described with respect to the image capturing apparatus 100 of FIG. 1. Referring to FIGS. 2A-3, in some examples, the image capturing apparatus 200 may also include amounting member 21.

Referring to FIGS. 2A-3, in some examples, the image capturing member 10 may capture an image of a target 25. For example, the image capturing member 10 may be a scanner to scan the target 25 to form an image, a camera to take a picture of the target 25, and the like. The target 25 may be a photograph, a document, an object, and the like. The platen 12 may include a receiving member 13 having at least one reference guide pattern 24a and 24b. At least one reference guide pattern 24a and 24b may be formed of a translucent section 34. For example, the translucent section 34 of the reference guide pattern 24a and 24b may pass and diffuse light provided by an illumination member 15 to provide an illuminated target reference. In some examples, the translucent section 34 may be semi-opaque. Accordingly, in some examples, the reference guide pattern 24a and 24b may blend into the industrial design of the receiving member 13 and/or platen 12 in the illumination-off mode as illustrated in FIG. 2C. The receiving member 13 may receive the target 25 for the image capturing member 10 to capture the image thereof. For example, the receiving member 13 may be a substantially flat receiving surface.

Referring to FIGS. 2A-3, in some examples, the illumination member 15 may selectively provide a target reference to guide placement of the target 25 within a field of view of the image capturing member 10 by illuminating at least one reference guide pattern 24a and 24b in an illumination-mode. For example, the illumination member 15 may be turned on in the illumination-on mode. In some examples, the illumination member 15 may be disposed behind the receiving member 13 and/or in a cavity 36 of the platen 12. Accordingly, at least one reference guide pattern 24a and 24b may be backside illuminated guides. In an illumination-off mode, the illumination member 15 may selectively disable the target reference by not illuminating at least one reference guide pattern 24a and 24b. For example, the illumination member 15 may be turned off in the illumination-off mode. Alternatively, in some examples, the target reference may be disabled by shielding the illumination member 15 from illuminating the target reference. In some examples, the illumination member 15 may be a light source such as light bulbs, light emitting diodes, and the like.

Referring to FIGS. 2A-3, in some examples, the platen 12 may also include a base member 39, an intermediate member 37 disposed behind the receiving member 13, and a cavity 36 formed between the intermediate member 37 and the base member 39. In some examples, each one of the receiving member 13, the base member 39, and the intermediate member 37 may include an opaque area having a same color. The mounting member 21 may include a first end 21a coupled to the image capturing member 10 and a second end 21b coupled to the platen 12.

Referring to FIGS. 2A-3, in some examples, the mounting member 21 may include an extended state (FIG. 2B) in which the image capturing member 10 coupled thereto is spaced apart and extended above the receiving member 13 to capture the image of the target 25 received on the receiving member 13. The mounting member 21 may include a retracted state (FIG. 2C) in which the image capturing member 10 coupled thereto and the mounting member 21 are placed in a mounting receiving area adjacent to sides of the platen 12. In some examples, at least one reference guide pattern 14 may include a plurality of reference guide patterns 24a and 24b. Each one of the reference guide patterns 24a end 24b may correspond to a respective target having a different size. For example, a first target may be a 5 by 7 inch photograph and a second target may be an 8½ inch sheet of paper.

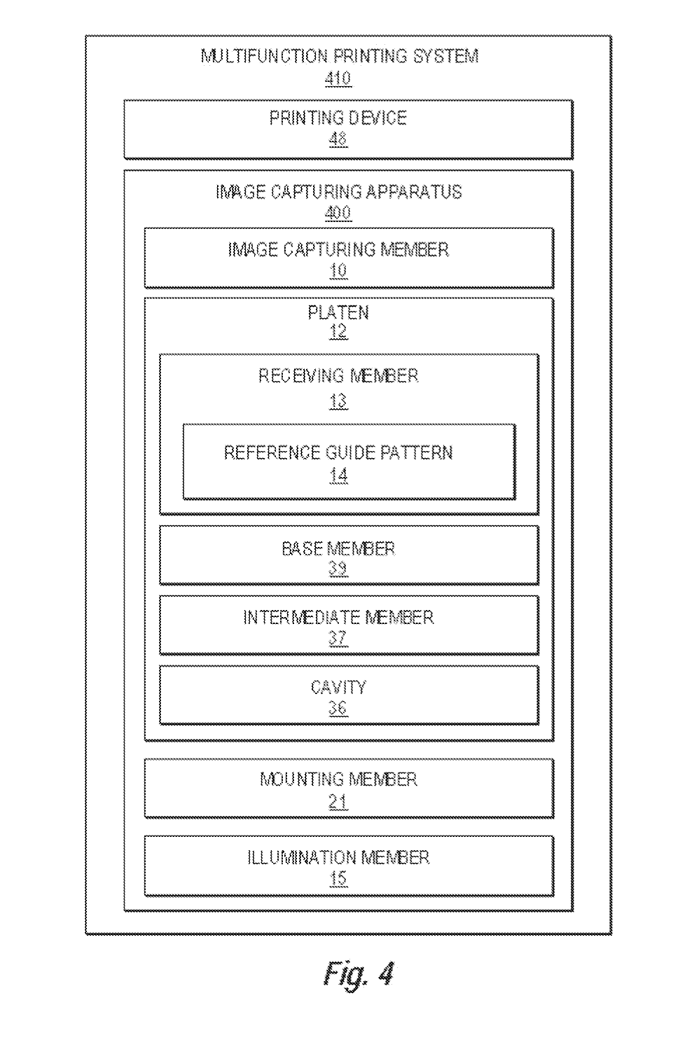

FIG. 4 is a block diagram illustrating a multifunction printing system according to an example. Referring to FIG. 4, in some examples, a multifunction printing system 410 includes a printing device 48 and an image capturing apparatus 400. The printing device 48 may form a printed image on a substrate. For example, the printing device 48 may include a print bar, printhead modules, binary ink developers, and the like. In some examples, the image capturing apparatus 400 may include the image capturing member 10, the illumination member 15, the mounting member 21, and the platen 12 including the receiving member 13, the base member 39, the intermediate member 37, and the cavity 36 as previously described with respect to FIGS. 1-3. The image capturing member 10 may capture an image of a target. The intermediate member 37 may be disposed behind the receiving member 13. The cavity 36 may be formed between the intermediate member 37 and the base member 39. The receiving member 13 may include a reference guide pattern 14 formed of a translucent section. The receiving member 13 may receive the target for the image capturing member 10 to capture the image thereof.

The mounting member 21 may mount the image capturing member 10 thereon a distance away from the receiving member 13. The mounting member 21 may include an extended state (FIG. 2B) in which the image capturing member 10 coupled thereto is spaced apart and extended above the receiving member 13 to capture the image of the target received on the receiving member 13. The mounting member 21 may also include a retracted state (FIG. 2C) in which the image capturing member 10 coupled thereto and the mounting member 21 are placed in a mounting receiving area adjacent to sides of the platen 12. The illumination member 15 may selectively provide a target reference to guide placement of the target within a field of view of the image capturing member 10 by illuminating the reference guide pattern 14 in an illumination-on mode. The illumination member 15 may disable the target reference by not illuminating the reference guide pattern 14 in an illumination-off mode. Alternatively, in some examples, the target reference may be disabled by shielding the illumination member 15 from illuminating the target reference.

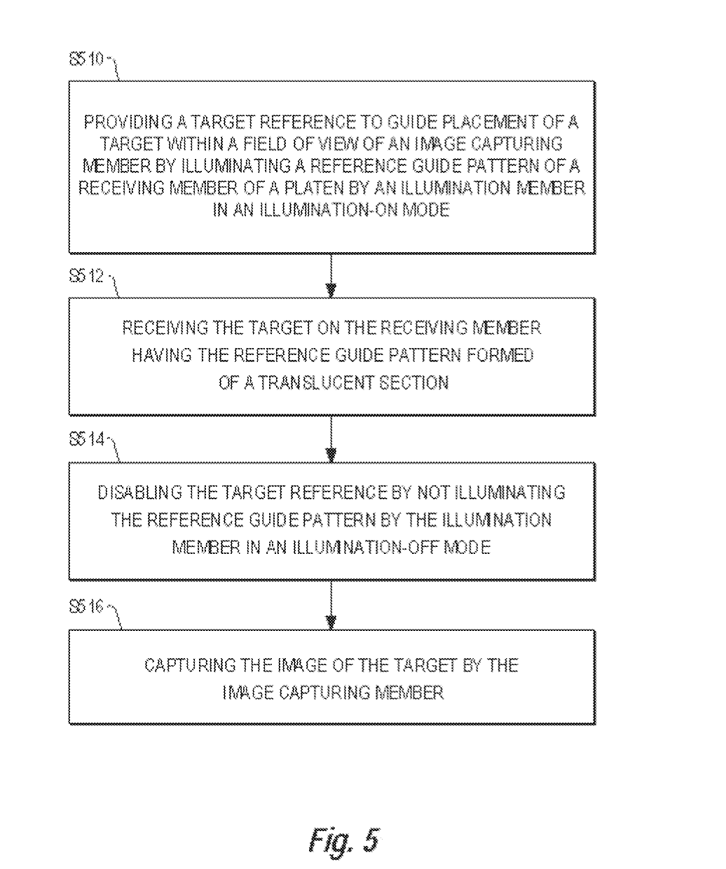

FIG. 5 is a to flowchart illustrating a method of capturing an image of a target according to an example. Referring to FIG. 5, in to block S510, a target reference to guide placement of the target within a field of view of an image capturing member is provided by illuminating a reference guide pattern of a receiving member of a platen by an illumination member in an illumination-on mode. In block S512, the target is received on the receiving member having the reference guide pattern formed of a translucent section. For example, the translucent section of the reference guide pattern may pass and diffuse light provided by an illumination member to preside an illuminated target reference. In block S514, the target reference is disabled by not illuminating the reference guide pattern by the illumination member in an illumination-off mode. In some examples, the target reference is disabled prior to the capturing the image of the target by the image capturing member. In some examples, the target reference may be disabled by turning off the illumination member. Alternatively, the target reference may be disabled by shielding the illumination member from illuminating the target reference. In block S516, the image of the target is captured by the image capturing member. In some examples, capturing the image of the target by the image capturing member occurs after providing the target reference to guide placement of the target within the field of view of the image capturing member.

It is to be understood that the flowchart of FIG. 5 illustrates architecture, functionality, and/or operation of examples of the present disclosure. If embodied in software, each block may represent a module, segment, or portion of code that includes one or more executable instructions to implement the specified logical function(s). If embodied in hardware, each block may represent a circuit or a number of interconnected circuits to implement the specified logical function(s). Although the flowchart of FIG. 5 illustrates a specific order of execution, the order of execution may differ from that which is depicted. For example, the order of execution of two or more blocks may be arranged relative to the order illustrated. Also, two or more blocks illustrated in succession in FIG. 5 may be executed concurrently or with partial concurrence. All such variations are within the scope of the present disclosure.

The present disclosure has been described using non-limiting detailed descriptions of examples thereof that are not intended to limit the scope of the general inventive concept. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are replaceable by equivalents, which perform the same function, even if the structure or acts are different, as known in the art. Therefore, the scope of the general inventive concept is limited only by the elements and imitations as used in the claims.

What is claimed is:

1. A method of capturing an image of a target, the method comprising:
providing a target reference to guide placement of the target within a field of view of an image capturing member by illuminating a reference guide pattern of a receiving member of a platen by an illumination member in an illumination-on mode;
receiving the target on the receiving member having the reference guide pattern formed of a translucent section;
disabling the target reference by not illuminating the reference guide pattern by the illumination member in an illumination-off mode; and
capturing the image of the target by the image capturing member.

2. The method according to claim 1, wherein the disabling the target reference by not illuminating the reference guide pattern by the illumination member in an illumination-off mode occurs prior to the capturing the image of the target by the image capturing member.

3. The method according to claim 2, wherein the capturing the image of the target by the image capturing member occurs after the providing the target reference to guide placement of the target within the field of view of the image capturing member.

4. The method according to claim 1, wherein the platen further comprises:
a base member, an intermediate member disposed behind the receiving member, and a cavity formed between the intermediate member and the base member.

5. The method according to claim 4, wherein each one of the receiving member, the base member, the intermediate member, and the receiving member includes an opaque area having a same color, and wherein the translucent section is semi-opaque.

6. An image capturing apparatus, comprising:
an image capturing member to capture an image of a target;
a platen including a receiving member having at least one reference guide pattern, the receiving member to receive the target for the image capturing member to capture the image thereof; and
an illumination member to selectively provide a target reference to guide placement of the target within a field of view of the image capturing member by illuminating the at least one reference guide pattern in an illumination-on mode and disable the target reference by not illuminating the at least one reference guide pattern in an illumination-off mode.

7. The image capturing apparatus according to claim 6, wherein the at least one reference guide pattern is formed of a translucent section.

8. The image capturing apparatus according to claim 7, wherein the illumination member is disposed behind the receiving member.

9. The image capturing apparatus according to claim 7, wherein the platen further comprises:
a base member, an intermediate member disposed behind the receiving member, and a cavity formed between the intermediate member and the base member.

10. The image capturing apparatus according to claim 9, wherein the illumination member is disposed in the cavity.

11. The image capturing apparatus according to claim 7, wherein each one of the receiving member, the base member, and the intermediate member includes an opaque area having a same color.

12. The image capturing apparatus according to claim 11, wherein the translucent section is semi-opaque.

13. The image capturing apparatus according to claim 6, further comprising:
a mounting member having a first end coupled to the image capturing member and a second end coupled to the platen.

14. The image capturing apparatus according to claim 7, wherein the at least one reference guide pattern includes a plurality of reference guide patterns, each one of the reference guide patterns corresponding to a respective target having a different size.

15. A multifunction printing system, comprising;
a printing device to form a printed image on a substrate; and
an image capturing apparatus, comprising:
an image capturing member to capture an image of a target;
a platen including a receiving member, a base member, an intermediate member disposed behind the receiving member, and a cavity formed between the intermediate member and the base member;
the receiving member including a reference guide patterns formed of a translucent section, the receiving member to receive the target for the image capturing member to capture the image thereof;
a mounting member to mount the image capturing member thereon a distance away from the receiving member; and
an illumination member to selectively provide a target reference to guide placement of the target within a field of view of the image capturing member by illuminating the reference guide pattern in an illumination-on mode and disable the target reference by not illuminating the reference guide pattern in an illumination-off mode.
